(19) United States
(12) Patent Application Publication
(10) Pub. No.: US 2024/0144308 A1
(43) Pub. Date: May 2, 2024

(54) METHOD AND SYSTEM FOR STANDARDIZED COMMODITY PRICING OF DATA ASSETS

(71) Applicant: Joel L. HENSON, Vienna, VA (US)

(72) Inventor: Joel L. HENSON, Vienna, VA (US)

(21) Appl. No.: 17/963,785

(22) Filed: Oct. 11, 2022

(51) Int. Cl. G06Q 30/0201; G06Q 40/04

(52) U.S. Cl. CPC G06Q 30/0206; G06Q 40/04

(57) ABSTRACT

A computerized method for commodity pricing of a data asset for a data exchange. The method includes determining a data type or category for the data asset from a library of data types; determining a unit of measure for the data asset; grading the data asset; determining a delivery method for the data asset; and calculating the commodity pricing for the data asset. A data asset valuation computer platform for commodity pricing of a data asset for a data exchange is also provided.

### FIELD

The present disclosure relates generally to methods and systems for the pricing of data assets.

### BACKGROUND

A commodity is an economic good, usually a resource, which has full or substantial fungibility, that is, the market treats instances of the good as equivalent or so with no regard to who produced them. Data is a unique commodity with fundamentally different market forces that contribute to its market value. Data is inexhaustible, infinitely replicated, with increasingly ubiquitous sources. It varies to a degree in quality, timeliness, and scarcity. While data has been described as “the new oil” it has yet to be treated consistently as a commodity.

To be a true commodity the guidance from the Chicago Mercantile Exchange has direct applicability. The exchange will standardize everything, from quality and quantity to the place of delivery, so that only the price is variable. This gives both the seller and the purchaser confidence.

There are currently no regulated commercial data exchanges to support the buying and selling of data as a commodity, at least in part because there has been no attempt to define data as a commodity that can be consistently priced.

Thus, there exists a need for improved methods and systems for the pricing of data assets.

### SUMMARY

In one aspect, provided is a computerized method for commodity pricing of a data asset for use in a data exchange. The method includes the steps of determining a data type or category for the data asset from a library of data types; determining a unit of measure for the data asset; grading the data asset; determining a delivery method for the data asset; and calculating the commodity pricing for the data asset.

In some embodiments, the data type or category is selected from signal intelligence, measure and signature intelligence, geospatial intelligence, human intelligence, or cyber intelligence.

In some embodiments, the unit of measure is selected from a square kilometer, a tile, a grid position, longitude and latitude, a polygon, a country, or a region.

In some embodiments, the step of grading the data asset includes a grading category of relevance, quality, saturation, and timeliness of the data asset.

In some embodiments, the step of grading the relevance of the data asset includes an assessment of need, priority, source, and uniqueness of the data asset.

In some embodiments, the step of grading the quality of the data asset includes an assessment for completeness, consistency, accuracy, validity, and timeliness of the data asset.

In some embodiments, the step of grading the saturation of the data asset includes an assessment of geological footprint, ubiquity, and target audience of the data asset.

In some embodiments, the step of grading the timeliness of the data asset includes an assessment of latency, intermediate processing prior to delivery, and degree of sensor stability.

In some embodiments, the delivery method is selected from physical media, File Transfer Protocol (FTP), Secure File Transfer Protocol (SFTP), Managed File Transfer, Application Programming Interface (API), and Streaming Near-Realtime (SNR).

In some embodiments, the method further includes the step of calculating weighting factors for each grading category.

In some embodiments, the step of calculating weighting factors further includes using an analytical hierarchy process to define, prioritize, and compare each weighting factor by using an eigenvector method to determine an eigenvalue for each weighting factor.

In some embodiments, the method further includes the step of performing a sensitivity analysis on each weighting factor.

In some embodiments, the method further includes the step of repeating the analytical hierarchy process upon producing new weighting factor information.

In some embodiments, the weighting factors are selected from the group of relevance, quality, saturation, and timeliness.

In some embodiments, the method further includes the step of self-scoring each grading category.

In some embodiments, the method further includes the step of multiplying each self-score by its respective weighting factor to calculate a product for each grading category.

In some embodiments, the method further includes the step of adding each product calculated for each grading category to determine a refined score.

In some embodiments, the method further includes the step of taking an average of each self-score.

In some embodiments, the method further includes the step of multiplying the refined score by 2.5×10⁶ to determine a data asset value if the average of each self-score is between 2.5 and 5.0.

In some embodiments, the method further includes the step of multiplying the refined score by 2.0×10⁶ to determine a data asset value if the average of each self-score is between 2.1 and 3.4.

In some embodiments, the method further includes the step of multiplying the refined score by 1.5×10⁶ to determine a data asset value if the average of each self-score is between 0.0 and 2.0.

In some embodiments, the method further includes the step of estimating the number of times a data asset will be sold to a customer to determine an asset allocation value.

In some embodiments, the method further includes the step of multiplying the data asset value by the asset allocation value to arrive at a data asset price.

In another aspect, disclosed herein is a data asset valuation computer platform for commodity pricing of a data asset for a data exchange. The data asset valuation computer platform includes a server including a processor for executing a set of instructions and a memory for storing the set of instructions; and a plurality of data asset platforms in communication with the server configured to store data pertaining to the data assets; wherein the instructions are executed by the processor for the server to value the data assets, associate the data assets with the data asset platforms, receive information for the data assets, and perform commodity pricing based on the information.

In some embodiments, the set of instructions stored in memory include the following instructions: determining a data type or category for the data asset from a library of data types; determining a unit of measure for the data asset; grading the data asset; determining a delivery method for the data asset; and calculating the commodity pricing for the data asset.

In some embodiments, the data type or category is selected from signal intelligence, measure and signature intelligence, geospatial intelligence, human intelligence, or cyber intelligence.

In some embodiments, the unit of measure is selected from a square kilometer, a tile, a grid position, longitude and latitude, a polygon, a country, or a region.

In some embodiments, the instruction of grading the data asset includes a grading category of relevance, quality, saturation, and timeliness of the data asset.

In some embodiments, the instruction of grading the relevance of the data asset includes an assessment of need, priority, source, and uniqueness of the data asset.

In some embodiments, the instruction of grading the quality of the data asset includes an assessment for completeness, consistency, accuracy, validity, and timeliness of the data asset.

In some embodiments, the instruction of grading the saturation of the data asset includes an assessment of geological footprint, ubiquity, and target audience of the data asset.

In some embodiments, the instruction of grading the timeliness of the data asset includes an assessment of latency, intermediate processing prior to delivery, and degree of sensor stability.

In some embodiments, the delivery method is selected from physical media, File Transfer Protocol (FTP), Secure File Transfer Protocol (SFTP), Managed File Transfer, Application Programming Interface (API), and Streaming Near-Realtime (SNR).

In some embodiments, weighting factors are calculated weighting factors for each grading category.

In some embodiments, the weighting factors are calculated using an analytical hierarchy process to define, prioritize, and compare each weighting factor by using an eigenvector method to determine an eigenvalue for each weighting factor.

In some embodiments, a sensitivity analysis is performed on each weighting factor.

In some embodiments, the analytical hierarchy process is repeated upon producing new weighting factor information.

In some embodiments, the weighting factors are selected from the group of relevance, quality, saturation, and timeliness.

In some embodiments, the set of instructions includes the instruction of self-scoring each grading category.

In some embodiments, the set of instructions includes the instruction of multiplying each self-score by its respective weighting factor to calculate a product for each grading category.

In some embodiments, the set of instructions includes the instruction of adding each product calculated for each grading category to determine a refined score.

In some embodiments, the set of instructions includes the instruction of taking an average of each self-score.

In some embodiments, the set of instructions includes the instruction of multiplying the refined score by 2.5×10⁶ to determine a data asset value if the average of each self-score is between 2.5 and 5.0.

In some embodiments, the set of instructions includes the instruction of multiplying the refined score by 2.0×10⁶ to determine a data asset value if the average of each self-score is between 2.1 and 3.4.

In some embodiments, the set of instructions includes the instruction of multiplying the refined score by 1.5×10⁶ to determine a data asset value if the average of each self-score is between 0.0 and 2.0.

In some embodiments, the set of instructions includes the instruction of estimating the number of times a data asset will be sold to a customer to determine an asset allocation value.

In some embodiments, the set of instructions includes the instruction of multiplying the data asset value by the asset allocation value to arrive at a data asset price.

As may be seen, the present disclosure provides the foundation for regulated trading of data as a commodity on a digital mercantile exchange. The present disclosure provides a mechanism to describe and curate data to ensure adherence to standards of quantity, quality, and place of delivery. Moreover, it provides the foundation for regulated trading of data as a commodity on a digital mercantile exchange by establishing an approach to standardization necessary to give buyers and sellers sufficient confidence to determine mutually acceptable pricing.

### BRIEF DESCRIPTION OF THE DRAWINGS

The present disclosure is susceptible to various modifications and alternative forms, specific exemplary implementations thereof have been shown in the drawings and are herein described in detail. It should be understood, however, that the description herein of specific exemplary implementations is not intended to limit the disclosure to the particular forms disclosed herein. This disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles. Further where considered appropriate, reference numerals may be repeated among the drawings to indicate corresponding or analogous elements. Moreover, two or more blocks or elements depicted as distinct or separate in the drawings may be combined into a single functional block or element. Similarly, a single block or element illustrated in the drawings may be implemented as multiple steps or by multiple elements in cooperation. The forms disclosed herein are illustrated by way of example, and not by way of limitation, in the figures of the accompanying drawings and in which like reference numerals refer to similar elements and in which:

FIG. 1 is a schematic representation of illustrative, non-exclusive examples of a method that assesses a set of pricing elements, which include a set of bounding elements, according to the present disclosure.

FIG. 2 is a schematic block diagram of illustrative, non-exclusive examples of a sequence of standardizing pricing elements with demand and price as the variable elements, according to the present disclosure.

FIGS. 3 and 4 presents a schematic block diagram of illustrative, non-exclusive examples of a computerized method 300 for commodity pricing of a data asset for use in a data exchange, according to the present disclosure.

FIG. 5 is a pictorial representation of a system for a data asset valuation computer platform for commodity pricing of a data asset, in accordance with an illustrative embodiment of the present disclosure.

### DETAILED DESCRIPTION

### Terminology

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

A/an: The articles “a” and “an” as used herein mean one or more when applied to any feature in embodiments and implementations of the present invention described in the specification and claims. The use of “a” and “an” does not limit the meaning to a single feature unless such a limit is specifically stated. The term “a” or “an” entity refers to one or more of that entity. As such, the terms “a” (or “an”), “one or more” and “at least one” can be used interchangeably herein.

About: As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

And/or: The term “and/or” placed between a first entity and a second entity means one of (1) the first entity, (2) the second entity, and (3) the first entity and the second entity. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements). As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either” “one of,” “only one of,” or “exactly one of”.

Any: The adjective “any” means one, some, or all indiscriminately of whatever quantity.

At least: As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements). The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Based on: “Based on” does not mean “based only on”, unless expressly specified otherwise. In other words, the phrase “based on” describes both “based only on,” “based at least on,” and “based at least in part on.”

Comprising: In the claims, as well as in the specification, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Couple: Any use of any form of the terms “connect”, “engage”, “couple”, “attach”, or any other term describing an interaction between elements is not meant to limit the interaction to direct interaction between the elements and may also include indirect interaction between the elements described.

Determining: “Determining” encompasses a wide variety of actions and therefore “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

Embodiments: Reference throughout the specification to “one embodiment,” “an embodiment,” “some embodiments,” “one aspect,” “an aspect,” “some aspects,” “some implementations,” “one implementation,” “an implementation,” or similar construction means that a particular component, feature, structure, method, or characteristic described in connection with the embodiment, aspect, or implementation is included in at least one embodiment and/or implementation of the claimed subject matter. Thus, the appearance of the phrases “in one embodiment” or “in an embodiment” or “in some embodiments” (or “aspects” or “implementations”) in various places throughout the specification are not necessarily all referring to the same embodiment and/or implementation. Furthermore, the particular features, structures, methods, or characteristics may be combined in any suitable manner in one or more embodiments or implementations.

Exemplary: “Exemplary” is used exclusively herein to mean “serving as an example, instance, or illustration.” Any embodiment described herein as “exemplary” is not necessarily to be construed as preferred or advantageous over other embodiments.

Flow diagram: Exemplary methods may be better appreciated with reference to flow diagrams or flow charts. While for purposes of simplicity of explanation, the illustrated methods are shown and described as a series of blocks, it is to be appreciated that the methods are not limited by the order of the blocks, as in different embodiments some blocks may occur in different orders and/or concurrently with other blocks from that shown and described. Moreover, less than all the illustrated blocks may be required to implement an exemplary method. In some examples, blocks may be combined, may be separated into multiple components, may employ additional blocks, and so on. In some examples, blocks may be implemented in logic. In other examples, processing blocks may represent functions and/or actions performed by functionally equivalent circuits (e.g., an analog circuit, a digital signal processor circuit, an application specific integrated circuit (ASIC)), or other logic device. Blocks may represent executable instructions that cause a computer, processor, and/or logic device to respond, to perform an action(s), to change states, and/or to make decisions. While the figures illustrate various actions occurring in serial, it is to be appreciated that in some examples various actions could occur concurrently, in series, and/or at substantially different points in time. In some examples, methods may be implemented as processor executable instructions. Thus, a machine-readable medium may store processor executable instructions that if executed by a machine (e.g., processor) cause the machine to perform a method.

May: Note that the word “may” is used throughout this application in a permissive sense (i.e., having the potential to, being able to), not a mandatory sense (i.e., must).

Operatively connected and/or coupled: Operatively connected and/or coupled means directly or indirectly connected for transmitting or conducting information, force, energy, or matter.

Optimizing: The terms “optimal,” “optimizing,” “optimize,” “optimality,” “optimization” (as well as derivatives and other forms of those terms and linguistically related words and phrases), as used herein, are not intended to be limiting in the sense of requiring the present invention to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the scope of the present invention, are more general. The terms may describe one or more of: 1) working towards a solution which may be the best available solution, a preferred solution, or a solution that offers a specific benefit within a range of constraints; 2) continually improving; 3) searching for a high point or a maximum for an objective; 4) processing to reduce a penalty function; 5) seeking to maximize one or more factors in light of competing and/or cooperative interests in maximizing, minimizing, or otherwise controlling one or more other factors, etc.

Order of steps: It should also be understood that, unless clearly indicated to the contrary, in any methods claimed herein that include more than one step or act, the order of the steps or acts of the method is not necessarily limited to the order in which the steps or acts of the method are recited.

Ranges: Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and about 200, but also to include individual sizes such as 2, 3, 4, etc. and sub-ranges such as 10 to 50, 20 to 100, etc. Similarly, it should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

As used herein, the term “sensor” includes any electrical sensing device or gauge. The sensor may be capable of monitoring or detecting pressure, temperature, fluid flow, vibration, resistivity, or other formation data. Alternatively, the sensor may be a position sensor.

### Description

Specific forms will now be described further by way of example. While the following examples demonstrate certain forms of the subject matter disclosed herein, they are not to be interpreted as limiting the scope thereof, but as contributing to a complete description.

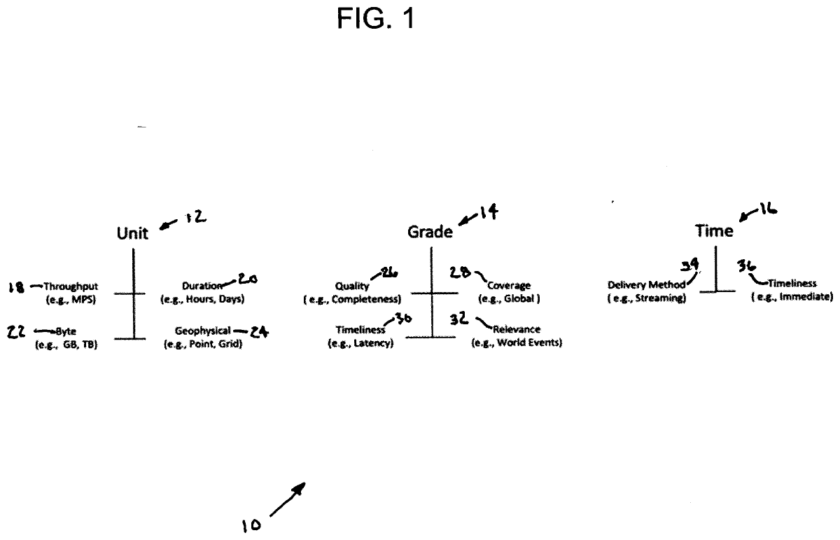

FIGS. 1-5 provide illustrative, non-exclusive examples of a system and method for a data asset valuation computer platform for commodity pricing of a data asset, in accordance with an illustrative embodiment of the present disclosure.

In FIGS. 1-5, like numerals denote like, or similar, structures and/or features; and each of the illustrated structures and/or features may not be discussed in detail herein with reference to the figures. Similarly, each structure and/or feature may not be explicitly labeled in the figures; and any structure and/or feature that is discussed herein with reference to the figures may be utilized with any other structure and/or feature without departing from the scope of the present disclosure.

In general, structures and/or features that are, or are likely to be, included in a given embodiment are indicated in solid lines in the figures, while optional structures and/or features are indicated in broken lines. However, a given embodiment is not required to include all structures and/or features that are illustrated in solid lines therein, and any suitable number of such structures and/or features may be omitted from a given embodiment without departing from the scope of the present disclosure.

Although the approach disclosed herein can be applied to a variety of commodities, the present description will primarily be directed to a computerized methods and systems for commodity pricing of a data asset for a data exchange.

Disclosed herein are methods and systems for the standardized commodity pricing of data assets, which treat data as a commodity as opposed to a retail object. Data sellers and buyers currently operate in four areas; 1) data aggregators, 2) data exchanges, 3) data brokers, and 4) data marketplaces.

Data aggregators are organizations that purchase data from a variety of sources and re-sell the data commercially using different proprietary pricing methods.

Current data exchanges are predominantly educational or governmental entities where data assets are shared with other stakeholders at little to no cost. They are not suitable for the commercial transactions in regulated commodity exchanges as they lack variable pricing mechanisms.

For data brokers, the customer defines the requirements, and the data broker selects the data sources. The customer gets what it specified. The data broker sets price, standards, and quality. The seller sets quantity and place of delivery.

In the data marketplace, data sources or their brokers define the data for sale and the customer chooses the best match. Price, standards, quality, quantity, and place of delivery set by the seller. The notion of caveat emptor applies.

The present disclosure provides the foundation for regulated commercial trading of data as a commodity on a digital mercantile exchange. As may be appreciated, there are currently no regulated data exchanges to support the buying and selling of data as a commodity. The present disclosure provides the mechanism to describe and curate the data to ensure adherence to standards of quantity, quality, and method of delivery. It provides the foundation for regulated trading of data as a commodity on a digital mercantile exchange.

The present disclosure enables the treatment of data as a commodity by standardizing units of measure, grades of data quality, and method of delivery to enable consistent treatment of like data.

Referring now to FIG. 1, the method disclosed herein assesses a set of pricing elements 10, which include a set of bounding elements. The bounding elements may include unit of measure 12, a grade of quality 14, and time 16. Attributes of the unit of measure 12 include throughput 18, duration 20, byte 22, and geophysical 24. Attributes of grade 14 include quality 26, coverage 28, timeliness (latency) 30, and relevance 32. Attributes of the bounding element of time 16 include a method of delivery 34 and timeliness (immediate) 36.

As may be appreciated, the pricing elements 10 recognize the fundamentally different market forces that contribute to data market value. While data is inexhaustible and infinitely replicated, with increasingly ubiquitous sources, it varies to a degree in quality 26, timeliness 30, and scarcity (not shown). These elements collectively aid in the determination of a data set's market value.

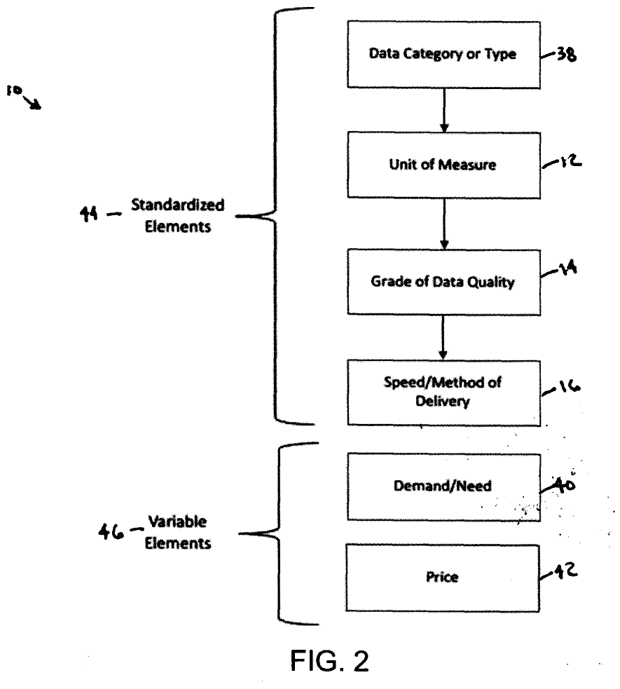

Referring now to FIG.1 and FIG. 2, the sequence of standardizing the pricing elements 10 with demand 40 and price 42 as the variable elements 46 is shown. When combined with the standardized elements 44 one can then answer the questions of: what do you want? how many/much? when do you want it?

The bounding element of unit of measure 12 recognizes that like other commodities, the unit of measure 12 can vary. For example, corn is traded by the bushel, oil by the barrel, etc. Units of measure 12 can vary by the data category and type. For example, geophysical data 20 is measured by dimensions. Internet protocol data is measured by nodes, and usage data by population. The intent of the unit of measure element 12 is to arrive at the lowest common denominator for a given data category or type for consistent comparison.

The element of grade 14 and quality 26 is analogous to commodities and their quality grade. Eggs are graded AA, A or B, oil has crudes graded by point of extraction. The Data Administration Management Association (DAMA) has well established grades of quality for data that include completeness, consistency, accuracy, and validity.

The element of time 16 may be specific to the method of delivery 34. This can range from physical media such as portable memory devices to streaming of data, such as video.

As may be appreciated, the variable elements 46 of demand 40 and price 42 are subject to market forces. The method and systems disclosed herein provide the foundation for regulated trading of data as a commodity on a digital mercantile exchange. It does this by providing the mechanism to describe and curate the data to ensure adherence to standards, quantity, quality, and place of delivery.

The method and systems disclosed herein provides a needed foundation for the regulated trading of data as a commodity on a digital mercantile exchange. The method and systems disclosed herein standardizes the unit of measure for a given data category or data type, the graded quality of the data, and the delivery method that will be used so that only the price is variable. These elements are necessary to establish the consistency and trust necessary to exchange data as a commodity.

Still referring to FIG. 2, the first component shown is data category or type 38 which enables the determination of what unit of measure 12 will be used in describing the commodity data.

As shown in Table 1, data category or type 38 is geospatial data type of satellite imagery that has monoscopic resolution and is in a raw format.

TABLE 1

| Data Type | Source | Resolution | Attribute |
|---|---|---|---|
| Geospatial (AKA: IMINT) | | | |
| | Satellite Imagery | | |
| | | Monoscopic | |
| | | | Raw |

The second component shown in FIG. 2 is the unit of measure 12. In the exemplar of Table 2, the data units of measure 12 for geospatial data are listed. A commonly used measure for satellite imagery are polygons, which are a set of spatially [Grab your reader's attention with a great quote from the document or use this space to emphasize a key point. To place this text box anywhere on the page, just drag it.]
explicit shapes that represent a geographic location. Spatial polygons are composed of vertices, which are sets of a series of x and y coordinates or spatial points. These polygons vary in shape and size but have a common denominator of square kilometers.

TABLE 2

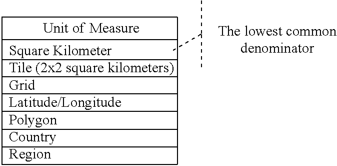

The third component shown in FIG. 2 is grade or data quality 14. The Data Quality Exemplar lists example quality attributes that can be assessed and graded. The example uses the Data Administration Management Association (DAMA) established and defined grades of quality for data that include completeness, consistency, accuracy, and validity.

TABLE 3

| Data Assessment | |
|---|---|
| Category | Data Category Sub Factors |
| Quality | Completeness |
| | Consistency |
| | Accuracy |
| | Validity |
| | Timeliness |
| Saturation | Geographical Footprint |
| | Ubiquity |
| | Target Audience |
| Timeliness | Low Latency - Collect to Distribute |
| | Limited Intermediate Stops (e.g., Aggregator) |
| | Low Risk of Disrupted Stream |

The fourth component shown in FIG. 2 is speed or delivery method 16. As shown in Table 4, a variety of data delivery methods can be used dependent based upon the data category/type and size of the data payload, as those skilled in the art will plainly understand.

TABLE 4
Delivery Method

Physical Media
File Transfer Protocol (FTP)
Secure File Transfer Protocol (SFTP)
Managed File Transfer
Application Programming Interface (API)
Streaming Near-Realtime

Still referring to FIG. 2, the data category or type 38 will inform the data unit of measure 12, which in turn, informs the grade or quality type 14 that would be applied. The data unit of measure 12 will bound the size of the data payload and its impact on the speed or method of delivery 16.

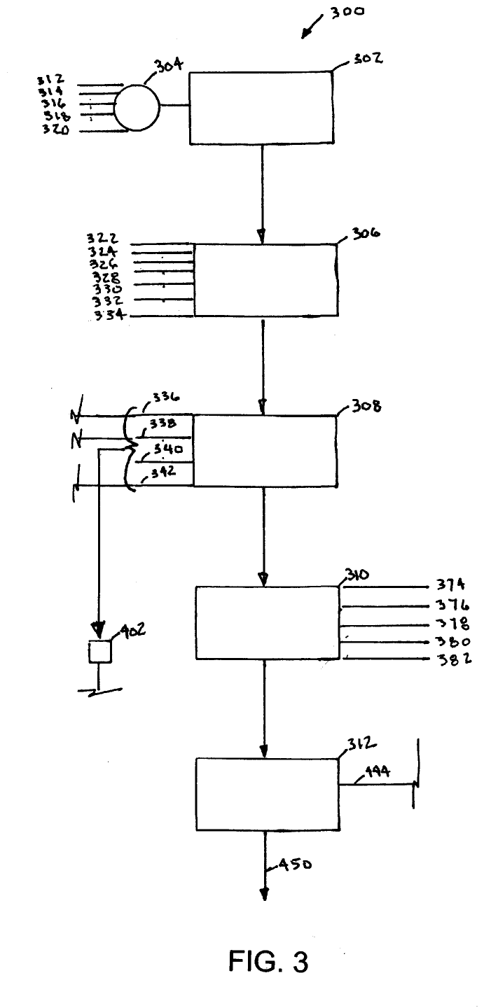

Referring now to FIG. 3, provided is a computerized method 300 for commodity pricing of a data asset for use in a data exchange. The method 300 includes the steps of determining a data type or category 302 for the data asset from a library of data types 304; determining a unit of measure for the data asset 306; grading the data asset 308; determining a delivery method for the data asset 310; and calculating the commodity pricing for the data asset 312.

In some embodiments, the data type or category 302 is selected from signal intelligence 312, measure and signature intelligence 314, geospatial intelligence 316, human intelligence 318, or cyber intelligence 320. In some embodiments, the unit of measure 306 is selected from a square kilometer 322, a tile 324, a grid position 326, longitude and latitude 328, a polygon 330, a country 332, or a region 334. In some embodiments, the step of grading the data asset 308 includes a grading category of relevance 336, quality 338, saturation 340, and timeliness 342 of the data asset.

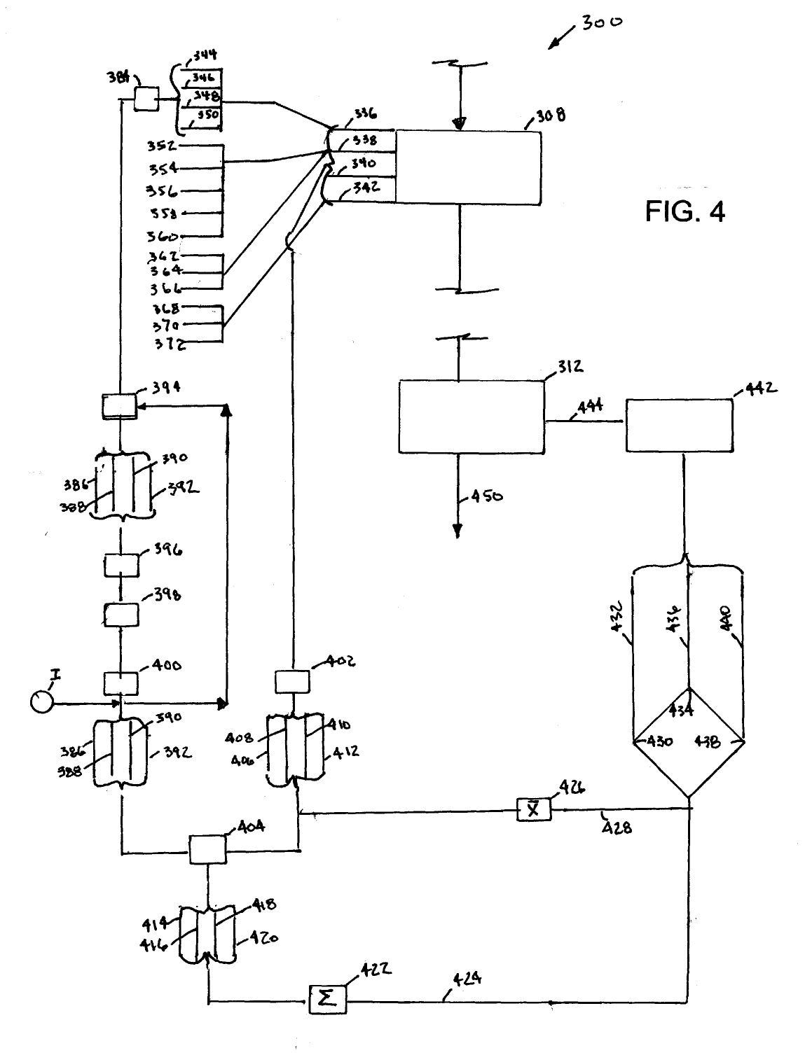

Referring also to FIG. 4, in some embodiments, the step of grading the relevance 336 of the data asset includes an assessment of need 344, priority 346, source 348, and uniqueness 350 of the data asset. In some embodiments, the step of grading the quality 338 of the data asset includes an assessment for completeness 352, consistency 354, accuracy 356, validity 358, and timeliness 360 of the data asset. In some embodiments, the step of grading the saturation 340 of the data asset includes an assessment of geological footprint 362, ubiquity 364, and target audience 366 of the data asset. In some embodiments, the step of grading the timeliness 342 of the data asset includes an assessment of latency 368, intermediate processing prior to delivery 370, and degree of sensor stability 372.

Referring to FIG. 3, in some embodiments, the delivery method 310 is selected from physical media, File Transfer Protocol (FTP) 374, Secure File Transfer Protocol (SFTP) 376, Managed File Transfer 378, Application Programming Interface (API) 380, and Streaming Near-Realtime (SNR) 382.

Still referring to FIG. 4, in some embodiments, the computerized method 300 further includes the step of calculating 384 weighting factors 386, 388, 390 and 392 for each grading category 336, 338, 340, and 342 (respectively). In some embodiments, the step of calculating 384 weighting factors 386, 388, 390 and 392 further includes using an analytical hierarchy process (AHP) 394 to define, prioritize, and compare each weighting factor 386, 388, 390 and 392 by using an eigenvector method 396 to determine an eigenvalue 398 for each weighting factor 386, 388, 390 and 392.

Still referring to FIG. 4, in some embodiments, the method 300 further includes the step of performing a sensitivity analysis 400 on each weighting factor 386, 388, 390 and 392. In some embodiments, the method 300 further includes the step of repeating the analytical hierarchy process (AHP) 394 upon producing new weighting factor information I. In some embodiments, the weighting factors 386, 388, 390 and 392 are selected from the group of relevance 336, quality 338, saturation 340, and timeliness 342.

In some embodiments, the method 300 further includes the step of self-scoring 402 each grading category 336, 338, 340, and 342. In some embodiments, the method 300 further includes the step of multiplying 404 each self-score 406, 408, 410, and 412 by its respective weighting factor 386, 388, 390 or 392 to calculate a product 414, 416, 418, and 420 for each grading category 336, 338, 340, and 342. In some embodiments, the method 300 further includes the step of adding 422 each product 414, 416, 418, and 420 calculated for each grading category 336, 338, 340, and 342 to determine a refined score 424. In some embodiments, the method 300 further includes the step of taking an average 426 of each self-score 406, 408, 410, and 412 to obtain an average value 428.

Still referring to FIG. 4, in some embodiments, the method 300 further includes the step 430 of multiplying the refined score 424 by 2.5×10⁶ to determine a data asset value 432 if the average 428 of the self-scores 406, 408, 410, and 412 is between 2.5 and 5.0. In some embodiments, the method 300 further includes the step 434 of multiplying the refined score 424 by 2.0×10⁶ to determine a data asset value 436 if the average 428 of the self-scores 406, 408, 410, and 412 is between 2.1 and 3.4. In some embodiments, the method 300 further includes the step 438 of multiplying the refined score 424 by 1.5×10⁶ to determine a data asset value 440 if the average of the self-scores 406, 408, 410, and 412 is between 0.0 and 2.0.

Referring to FIGS. 3 and 4, in some embodiments, the method 300 further includes the step of estimating the number of times a data asset will be sold to a customer 442 to determine an asset allocation value 444. In some embodiments, the method 300 further includes the step of multiplying the data asset value 432, 436, or 440 by the asset allocation value 444 to arrive at a data asset price 450.

AHP is a method of organizing and analyzing complex decisions. The process contains three parts: the ultimate goal or problem one is trying to solve, all possible solutions (alternatives), and the criteria for judging the alternatives. AHP provides a rational framework for a needed decision by quantifying its criteria and alternative options, and relating those elements to the overall goal.

The importance of criteria are compared, two at a time, through pair-wise comparisons. AHP converts these evaluations into numbers, which can be compared to all of the possible criteria. This quantifying capability distinguishes AHP from other decision-making techniques. In the ultimate step of the process, numerical priorities are calculated for each of the alternative options. These numbers represent the most desired solutions, based on user values.

AHP is most useful when finding decisions to complex problems with high stakes. It differs from other decision-making techniques as it quantifies criteria and options that traditionally are difficult to measure with hard numbers. Rather than prescribing a “correct” decision, AHP helps decision makers find one that best suits their values and their understanding of the problem.

The application of AHP begins with a problem being decomposed into a hierarchy of criteria so as to be more easily analyzed and compared in an independent manner. After this logical hierarchy is constructed, one can systematically assess the alternatives by making pair-wise comparisons for each of the chosen criteria. This comparison may use concrete data from the alternatives or human judgments as a way to input subjacent information.

AHP transforms the comparisons, which are often empirical, into numerical values that are further processed and compared. The weight of each factor allows the assessment of each one of the elements inside the defined hierarchy. After all the comparisons have been made, and the relative weights between each of the criteria to be evaluated have been established, the numerical probability of each alternative is calculated. This probability determines the likelihood that the alternative has to fulfill the expected goal. The higher the probability, the better the chances the alternative has to satisfy the final goal of the data set.

After the hierarchy has been established, the criteria must be evaluated in pairs so as to determine the relative importance between them and their relative weight to the global goal. The contribution of each criterion is determined by calculations made using a priority vector or Eigenvector.

The Eigenvector shows the relative weights between each criterion; it is obtained in an approximate manner by calculating the mathematical average of all criteria. Note that the sum of all values from the vector is always equal to one. A mathematical software application may be used to calculate the exact value for the Eigenvector through the use of potential matrices. The values found in the Eigenvector have a direct physical meaning in AHP; they determine the participation or weight of that criterion relative to the total result of the goal. The use of AHP requires a computer tailored specifically to performing the mathematical calculations.

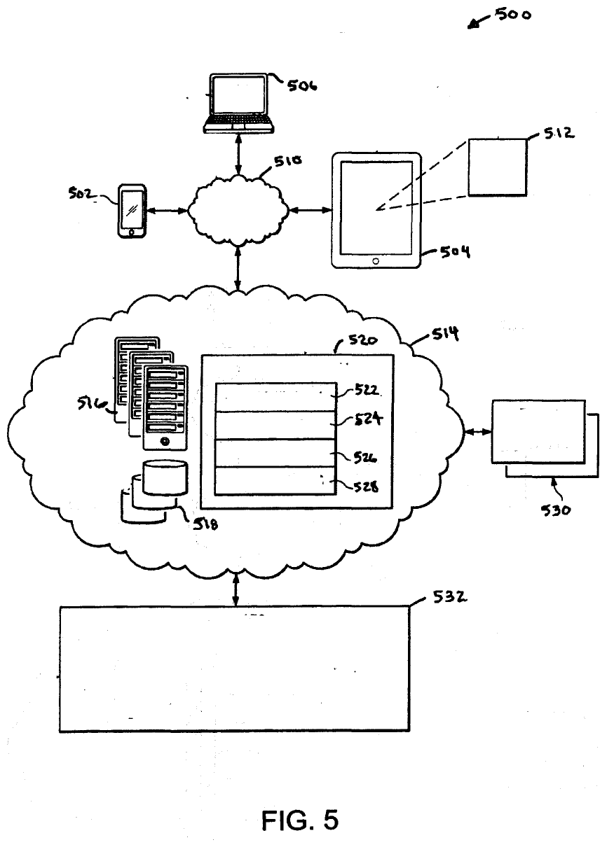

FIG. 5 is a pictorial representation of a system 500 for a data asset valuation computer platform for commodity pricing of a data asset, in accordance with an illustrative embodiment of the present disclosure. In one embodiment, the system 500 of FIG. 5 may include any number of devices, networks, components, software, hardware, and so forth. In one example, the system 500 may include a one or more devices, such as a smart phone 502, and/or a tablet 504 for displaying a graphical user interface 512, and/or a laptop or desktop 506, one or more networks 510, a cloud system 514, a plurality of servers 516, a plurality of databases 518, a data asset platform 520 including at least a logic engine 522, a memory 524, data sets 526, and transaction information 528. The cloud system 514 may further communicate with sources 532 and third-party resources 530.

Each of the devices, systems, and equipment of the system 500 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity.

In one embodiment, the system 500 may be utilized by any number of users, organizations, or providers to aggregate, manage, review, analyze, process, tokenize, distribute, advertise, market, display, and/or monetize data sets 526. In one embodiment, the system 500 may utilize any number of secure identifiers (e.g., passwords, pin numbers, certificates, etc.), secure channels, connections, or links, virtual private networks, biometrics, or so forth to upload, manage, and secure the data sets 526, generate tokens, and perform applicable transactions. System 500 may be a blockchain system that utilizes a digital ledger to track transactions involving the data sets 526 or utilization thereof. For example, the digital ledger may store the transaction details, information, and data. The devices may utilize any number of applications, browsers, gateways, bridges, or interfaces to communicate with the cloud system 514, data asset platform 520, and/or associated components.

The data sets 526 may include a number of different data types. The data sets 526 may include demographic data, commercial and consumer data, family and health data, property data, interests and activity data, and other applicable types of data. These data may be treated and valued as static data.

The wireless device 502, tablet 504, and laptop or desktop 506 are examples of common devices that may be utilized. Other examples of devices may include e-readers, cameras, video cameras, audio systems, gaming devices, vehicle systems, kiosks, point of sale systems, televisions, smart displays, monitors, entertainment devices, medical devices, virtual reality/augmented reality systems, or so forth. The devices may communicate wirelessly or through any number of fixed/hardwired connections, networks, signals, protocols, formats, or so forth. In one embodiment, the smart phone 502 is a cell phone that communicates with the network 510 through a 5G connection. The laptop or desktop 506 may communicate with the network 510 through an Ethernet, Wi-Fi connection, or other wired or wireless connection.

The cloud system 514 may aggregate, manage, analyze, and process information and tokens across the Internet and any number of networks, sources 532, and third-party resources 530. For example, the networks 510 and 514 may represent any number of public, private, virtual, specialty, or other network types or configurations. The different components of the system 500, including the devices may be configured to communicate using wireless communications, such as Bluetooth, Wi-Fi, or so forth. Alternatively, the devices may communicate utilizing satellite connections, Wi-Fi, 3G, 4G, 5G, LTE, personal communications systems, DMA wireless networks, and/or hardwired connections, such as fiber optics, T1, cable, DSL, high speed trunks, powerline communications, and telephone lines. Any number of communications architectures including client-server, network rings, peer-to- peer, n-tier, application server, mesh networks, fog networks, or other distributed or network system architectures may be utilized. The networks 510 and 514 of the system 500 may represent a single communication service provider or multiple communications services providers.

The sources 532 may represent any number of web servers, distribution services (e.g., text, email, video, etc.), media servers, platforms, distribution devices, or so forth. In one embodiment, the sources 532 may represent the businesses that purchase, license, or utilize the data sets 526. In one embodiment, the cloud system 514 (or alternatively the cloud network) including the data asset platform 520 is specially configured to perform the illustrative embodiments.

The cloud system 514 or network represents a cloud computing environment and network utilized to aggregate, process, manage, sell, and price data 526 and support the associated transactions and utilization. The cloud system 514 may implement a blockchain system. In addition, the cloud system 514 may remotely manage configuration, software, and computation resources for the devices of the system 500. The cloud system 514 may prevent unauthorized access tools, and resources stored in the servers 516, databases 518, and any number of associated secured connections, virtual resources, modules, applications, components, devices, or so forth. The cloud system 514 allows the overall system 500 to be scalable for quickly adding and removing users, businesses, authorized sellers, cause-based information, analysis modules, distributors, valuation logic, algorithms, moderators, programs, scripts, filters, transaction processes, distribution partners, or other users, devices, processes, or resources. Communications with the cloud system 514 may utilize encryption, secured tokens, secure tunnels, handshakes, secure identifiers (e.g., passwords, pins, keys, scripts, biometrics, etc.), firewalls, digital ledgers, specialized software modules, or other data security systems and methodologies as are known in the art. The platform is used as a vault for personal, user profile, corporate data and data pools that secure the data from standard internet profiling and targeting methods through the use of VPN's, secure networks, firewalls, and internet data encryption methodologies that ensure the vaulted data cannot be accessed without user profile permission. The cryptographic tokens that are generated in exchange for data storage and access represent a set of rules, encoded in a smart contract that ties the token contract to specific requirements to grant or deny access to each user or data point contained in a data profile.

Although not shown, the cloud system 514 may include any number of load balancers. The load balancer is one or more devices configured to distribute the workload of processing the uploaded data 526 as well as applicable transactions to optimize resource utilization, throughput, and minimize response time and overload. For example, the load balancer may represent a multilayer switch, database load balancer, or a domain name system server. The load balancer may facilitate communications and functionality (e.g., database queries, read requests, write requests, command communications, stream processing, etc.) between the devices and the cloud system 514. For example, the cloud system 514 may offload verification of users that seek to be added to the system 500 along with applicable data 526 and information. Load balancing may be performed between automatic systems and devices as well as individual users. Other intelligent network devices may also be utilized within the cloud system 514.

The servers 516 and databases 518 may represent a portion of the system 500. In one embodiment, the servers 516 may include a web server (not shown) utilized to provide a website, mobile applications, and user interface 512 for interfacing with numerous users. Information received by the web server may be managed by the data asset platform 520 managing the servers 516 and associated databases 518. For example, the web server may communicate with the database 518 to respond to read and write requests. For example, the servers 516 may include one or more servers dedicated to implementing and recording blockchain transactions and communications regarding the datasets 526. The databases 518 may utilize any number of database architectures and database management systems (DBMS) as are known in the art. The databases 518 may store the content associated with each potential purchaser. Any number of secure identifiers, such as tones, QR codes, serial numbers, or so forth may be utilized to ensure that content, is not improperly shared or accessed.

The user interface 512 may be made available through the various devices of the system 500. In one embodiment, the user interface 512 represents a graphical user interface, audio interface, or other interface that may be utilized to manage data and information. For example, the user may enter, or update associated data utilizing the user interface 512 (e.g., browser or application on a mobile device). The user interface 512 may be presented based on execution of one or more applications, browsers, kernels, modules, scripts, operating systems, or specialized software that is executed by one of the respective devices. The user interface may display current and historical data as well as trends. The user interface 512 may be utilized to set the user preferences, parameters, and configurations of the devices as well as upload and manage the data, content, and implementation preferences sent to the cloud system 514.

In one embodiment, the system 500 or the cloud system 514 may also include the data asset platform 520 which is one or more devices utilized to enable, initiate, generate, aggregate, analyze, process, and manage information, and so forth with one or more communications or computing devices. The data asset platform 520 may include one or more devices networked to manage the cloud network and system 514. For example, the data asset platform 520 may include any number of servers, routers, switches, or advanced intelligent network devices. For example, the data asset platform 520 may represent one or more web servers that performs the processes and methods herein described.

In one embodiment, the logic engine 522 is the logic that controls various algorithms, programs, hardware, and software that interact to receive, aggregate, analyze, rank, process, score, communicate, and distribute data, content, transactions, alerts, reports, messages, or so forth. The logic engine 522 may utilize any number of thresholds, parameters, criteria, algorithms, instructions, or feedback to interact with users and interested parties and to perform other automated processes. The logic engine 522 may represent a processor. The processor is circuitry or logic enabled to control execution of a program, application, operating system, macro, kernel, or other set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 524 is a hardware element, device, or recording media configured to store data for subsequent retrieval or access at a later time. The memory 524 may be static or dynamic memory. The memory 524 may include a hard disk, random access memory, cache, removable media drive, mass storage, or configuration suitable as storage for data 526, transactions 528, instructions, and information. In one embodiment, the memory 524 and logic engine 522 may be integrated. The memory 524 may use any type of volatile or non-volatile storage techniques and mediums. In one embodiment, the memory 524 may store a digital ledger and tokens for implementing blockchain processes.

In one embodiment, the cloud system 514 or the data asset platform 520 may coordinate the methods and processes described herein as well as software synchronization, communication, and processes. The third-party resources 530 may represent any number of human or electronic resources utilized by the cloud system 514 including, but not limited to, businesses, entities, organizations, individuals, government databases, private databases, web servers, research services, and so forth. For example, the third-party resources 530 may represent those that pay for rights to use the data 526.

In one embodiment, the data asset platform 520 may implement a blockchain ledger, manager, or technology. In another embodiment, the blockchain ledger may be accessible through sources 532. Any number of existing blockchain companies or providers may be utilized (Aeternity, Ethereum, Bitcoin, Dfinity, ContentKid, Blockphase, Chain of Things, Flowchain, Decissio, Cognate, SkyHive, Safe, etc.).

The blockchain is utilized as a way to store and communicate the data 526 along with transactions 528. The blockchain may utilize one or more distinct ledgers for different entities, services providers, types of data, users, or so forth.

The third-party resources 530 may represent any number of electronic or other resources that may be accessed to perform the processes herein described. For example, the third-party resources 530 may represent government, and private servers, databases, websites, services, and so forth.

The logic engine 522 may perform valuation of the data 526. The logic engine 522 may also track and value data 526 between one or more companies to provide valuations as included in corporate transactions. Companies, entities, or other organizations may also value their data 526 and tie that value to their market capitalization providing public companies the ability to measure and place a valuation on data.

The illustrative embodiments may also support third-party valuations of data. The validations may be performed by auditing groups, commissions, industry groups, or other professionals/entities. In one embodiment, the sources 532 may determine or verify data valuations. The data that is improved and/or validated may increase in value. Any number of artificial intelligence or computerized processes may be utilized to validate data. The sources 532 may also aggregate data 526 into portfolios.

Data valuation may also be associated with geographic locations. The association of data with a location may be performed utilizing GPS data, location-based services, beacons, wireless triangulation, location-based services, tracking programs, interfaces, connections, protocols, video surveillance, or so forth. The data asset platform 520 can provide an owner of data 526 an effective way to value the data.

In one embodiment, the logic engine 522 may utilize artificial intelligence. The artificial intelligence may be utilized to enhance data 526 and increase its value. The artificial intelligence of the logic engine 522 may be utilized to ensure that the data 526 is improved, accurately analyzed, and value increased. For example, it is expected that data and the associated tokens that are validated utilizing artificial intelligence may be given a premium value by both buyers and sellers.

In another embodiment, the devices may include any number of sensors, appliances, and devices that utilize real time measurements and data collection to update the data 126. For example, a sensor network, and Internet of things (IOT) devices may gather data.

Referring still to FIG. 5, a further embodiment of a data asset valuation computer system 500 for the commodity pricing of a data asset will be discussed. The computer system 500 includes one or more servers 516 having a processor or logic engine 522 for executing a set of instructions resident with memory 524; and a plurality of data asset platforms 520 in communication with the servers 516 configured to store data 526 pertaining to the data assets.

The set of instructions may be executed by the processor or logic engine 522 to value the data assets 526, associate the data assets, receive information regarding the data assets, and perform a price determination based on the information.

In some embodiments, the set of instructions stored in memory include the following instructions: determining a data type or category for the data asset from a library of data types; determining a unit of measure for the data asset; grading the data asset; determining a delivery method for the data asset; and calculating the commodity pricing for the data asset.

In some embodiments, the data type or category is selected from signal intelligence, measure and signature intelligence, geospatial intelligence, human intelligence, or cyber intelligence.

In some embodiments, the unit of measure is selected from a square kilometer, a tile, a grid position, longitude and latitude, a polygon, a country, or a region.

In some embodiments, the instruction of grading the data asset includes a grading category of relevance, quality, saturation, and timeliness of the data asset.

In some embodiments, the instruction of grading the relevance of the data asset includes an assessment of need, priority, source, and uniqueness of the data asset.

In some embodiments, the instruction of grading the quality of the data asset includes an assessment for completeness, consistency, accuracy, validity, and timeliness of the data asset.

In some embodiments, the instruction of grading the saturation of the data asset includes an assessment of geological footprint, ubiquity, and target audience of the data asset.

In some embodiments, the instruction of grading the timeliness of the data asset includes an assessment of latency, intermediate processing prior to delivery, and degree of sensor stability.

In some embodiments, the delivery method is selected from physical media, File Transfer Protocol (FTP), Secure File Transfer Protocol (SFTP), Managed File Transfer, Application Programming Interface (API), and Streaming Near-Realtime (SNR).

In some embodiments, weighting factors are calculated weighting factors for each grading category.

In some embodiments, the weighting factors are calculated using an analytical hierarchy process to define, prioritize, and compare each weighting factor by using an eigenvector method to determine an eigenvalue for each weighting factor.

In some embodiments, a sensitivity analysis is performed on each weighting factor.

In some embodiments, the analytical hierarchy process is repeated upon producing new weighting factor information.

In some embodiments, the weighting factors are selected from the group of relevance, quality, saturation, and timeliness.

In some embodiments, the set of instructions includes the instruction of self-scoring each grading category.

In some embodiments, the set of instructions includes the instruction of multiplying each self-score by its respective weighting factor to calculate a product for each grading category.

In some embodiments, the set of instructions includes the instruction of adding each product calculated for each grading category to determine a refined score.

In some embodiments, the set of instructions includes the instruction of taking an average of each self-score.

In some embodiments, the set of instructions includes the instruction of multiplying the refined score by 2.5×10⁶ to determine a data asset value if the average of each self-score is between 2.5 and 5.0.

In some embodiments, the set of instructions includes the instruction of multiplying the refined score by 2.0×10⁶ to determine a data asset value if the average of each self-score is between 2.1 and 3.4.

In some embodiments, the set of instructions includes the instruction of multiplying the refined score by 1.5×10⁶ to determine a data asset value if the average of each self-score is between 0.0 and 2.0.

In some embodiments, the set of instructions includes the instruction of estimating the number of times a data asset will be sold to a customer to determine an asset allocation value.

In some embodiments, the set of instructions includes the instruction of multiplying the data asset value by the asset allocation value to arrive at a data asset price.

Illustrative, non-exclusive examples of assemblies, systems, and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

### INDUSTRIAL APPLICABILITY

The apparatus and methods disclosed herein are applicable to the collection and marketing of data to end users in government, and the private sector.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A computerized method for commodity pricing of a data asset for a data exchange, comprising:
(a) determining a data type or category for the data asset from a library of data types;
(b) determining a unit of measure for the data asset;
(c) grading the data asset;
(d) determining a delivery method for the data asset; and
(e) calculating the commodity pricing for the data asset.

2. The method of claim 1, wherein the data type or category is selected from signal intelligence, measure and signature intelligence, geospatial intelligence, human intelligence, or cyber intelligence.

3. The method of claim 1, wherein the unit of measure is selected from a square kilometer, a tile, a grid position, longitude and latitude, a polygon, a country, or a region.

4. The method of claim 1, wherein the step of grading the data asset includes a grading category of relevance, quality, saturation, and timeliness of the data asset.

5. The method of claim 4, wherein the step of grading the relevance of the data asset includes an assessment of need, priority, source, and uniqueness of the data asset.

6. The method of claim 5, wherein the step of grading the quality of the data asset includes an assessment for completeness, consistency, accuracy, validity, and timeliness of the data asset.

7. The method of claim 6 , wherein the step of grading the saturation of the data asset includes an assessment of geological footprint, ubiquity, and target audience of the data asset.

8. The method of claim 7, wherein the step of grading the timeliness of the data asset includes an assessment of latency, intermediate processing prior to delivery, and degree of sensor stability.

9. The method of claim 1, wherein the delivery method is selected from physical media, File Transfer Protocol (FTP), Secure File Transfer Protocol (SFTP), Managed File Transfer, Application Programming Interface (API), and Streaming Near-Realtime (SNR).

10. The method of claim 4, further comprising the step of calculating weighting factors for each grading category.

11. The method of claim 10, wherein the step of calculating weighting factors further comprises using an analytical hierarchy process to define, prioritize, and compare each weighting factor by using an eigenvector method to determine an eigenvalue for each weighting factor.

12. The method of claim 11, further comprising the step of performing a sensitivity analysis on each weighting factor.

13. The method of claim 12, further comprising the step of repeating the analytical hierarchy process of claim 11 upon producing new weighting factor information.

14. The method of claim 10, wherein the weighting factors are selected from the group of relevance, quality, saturation, and timeliness.

15. The method of claim 10, further comprising the step of self-scoring each grading category.

16. The method of claim 15, further comprising the step of multiplying each self-score by its respective weighting factor to calculate a product for each grading category.

17. The method of claim 16, further comprising the step of adding each product calculated for each grading category to determine a refined score.

18. The method of claim 15, further comprising the step of taking an average of each self-score.

19. The method of claim 18, further comprising the step of multiplying the refined score by 2.5×10⁶ to determine a data asset value if the average of each self-score is between 2.5 and 5.0.

20. The method of claim 18, further comprising the step of multiplying the refined score by 2.0×10⁶ to determine a data asset value if the average of each self-score is between 2.1 and 3.4.

21. The method of claim 18, further comprising the step of multiplying the refined score by 1.5×10⁶ to determine a data asset value if the average of each self-score is between 0.0 and 2.0.

22. The method of claim 19, further comprising the step of estimating the number of times a data asset will be sold to a customer to determine an asset allocation value.

23. The method of any of claims 22, further comprising the step of multiplying the data asset value by the asset allocation value to arrive at a data asset price.

24. A data asset valuation computer platform for commodity pricing of a data asset for a data exchange, comprising:
(a) a server including a processor for executing a set of instructions and a memory for storing the set of instructions; and
(b) a plurality of data asset platforms in communication with the server configured to store data pertaining to the data assets;
wherein the instructions are executed by the processor for the server to value the data assets, associate the data assets with the data asset platforms, receive information for the data assets, and perform commodity pricing based on the information.

25. The computer platform of claim 24, wherein the set of instructions stored in memory comprise:
(a) determining a data type or category for the data asset from a library of data types;
(b) determining a unit of measure for the data asset;
(c) grading the data asset;
(d) determining a delivery method for the data asset; and
(e) calculating the commodity pricing for the data asset.

26. The computer platform of claim 25, wherein the data type or category is selected from signal intelligence, measure and signature intelligence, geospatial intelligence, human intelligence, or cyber intelligence.

27. The computer platform of claim 25, wherein the unit of measure is selected from a square kilometer, a tile, a grid position, longitude and latitude, a polygon, a country, or a region.

28. The computer platform of claim 25, wherein the instruction of grading the data asset includes a grading category of relevance, quality, saturation, and timeliness of the data asset.

29. The computer platform of claim 28, wherein the instruction of grading the relevance of the data asset includes an assessment of need, priority, source, and uniqueness of the data asset.

30. The computer platform of claim 29, wherein the instruction of grading the quality of the data asset includes an assessment for completeness, consistency, accuracy, validity, and timeliness of the data asset.

31. The computer platform of claim 30 , wherein the instruction of grading the saturation of the data asset includes an assessment of geological footprint, ubiquity, and target audience of the data asset.

32. The computer platform of claim 31, wherein the instruction of grading the timeliness of the data asset includes an assessment of latency, intermediate processing prior to delivery, and degree of sensor stability.

33. The computer platform of claim 25, wherein the delivery method is selected from physical media, File Transfer Protocol (FTP), Secure File Transfer Protocol (SFTP), Managed File Transfer, Application Programming Interface (API), and Streaming Near-Realtime (SNR).

34. The computer platform of claim 28, wherein weighting factors are calculated weighting factors for each grading category.

35. The computer platform of claim 34, wherein the weighting factors are calculated using an analytical hierarchy process to define, prioritize, and compare each weighting factor by using an eigenvector method to determine an eigenvalue for each weighting factor.

36. The computer platform of claim 35, wherein a sensitivity analysis is performed on each weighting factor.

37. The computer platform of claim 36, wherein the analytical hierarchy process of claim 35 is repeated upon producing new weighting factor information.

38. The computer platform of claim 34, wherein the weighting factors are selected from the group of relevance, quality, saturation, and timeliness.

39. The computer platform of claim 38, wherein the instruction set further includes the instruction of self-scoring each grading category.

40. The computer platform of claim 39, wherein the instruction set further includes the instruction of multiplying each self-score by its respective weighting factor to calculate a product for each grading category.

41. The computer platform of claim 40, wherein the instruction set further includes the instruction of adding each product calculated for each grading category to determine a refined score.

42. The computer platform of claim 39, wherein the instruction set further includes the instruction of taking an average of each self-score.

43. The computer platform of claim 42, wherein the instruction set further includes the instruction of multiplying the refined score by 2.5×10⁶ to determine a data asset value if the average of each self-score is between 2.5 and 5.0.

44. The computer platform of claim 42, wherein the instruction set further includes the instruction of multiplying the refined score by 2.0×10⁶ to determine a data asset value if the average of each self-score is between 2.1 and 3.4.

45. The computer platform of claim 42, wherein the instruction set further includes the instruction of multiplying the refined score by 1.5×10⁶ to determine a data asset value if the average of each self-score is between 0.0 and 2.0.

46. The computer platform of claim 43, wherein the instruction set further includes the instruction of estimating the number of times a data asset will be sold to a customer to determine an asset allocation value.

47. The computer platform of any of claims 46, wherein the instruction set further includes the instruction of multiplying the data asset value by the asset allocation value to arrive at a data asset price.
